(19) United States
(12) Patent Application Publication
(10) Pub. No.: US 2023/0009726 A1
(43) Pub. Date: Jan. 12, 2023

(54) CLEAR KETTLE WITH DISPLAY

(71) Applicant: The Steelstone Group LLC, Brooklyn, NY (US)

(72) Inventor: Naphtali H. Biegeleisen, Brooklyn, NY (US)

(21) Appl. No.: 17/859,319

(22) Filed: Jul. 7, 2022

Related U.S. Application Data
(63) Continuation-in-part of application No. 29/798,782, filed on Jul. 9, 2021.
(60) Provisional application No. 63/219,006, filed on Jul. 7, 2021.

(51) Int. Cl. A47J 27/21; A47J 36/04

(52) U.S. Cl. CPC A47J 27/21008; A47J 27/21166; A47J 36/04

(57) ABSTRACT

A kettle is provided having a fluid chamber having a transparent or translucent wall and a display panel located in or on the transparent or translucent wall, wherein the display panel is surrounded on at least three sides by the translucent or transparent wall.

### CROSS-REFERENCE TO RELATED APPLICATION

This application takes priority from U.S. Provisional Patent Application No. 63/219,006 filed Jul. 7, 2021, the contents of which are incorporated by reference herein in their entirety. This application is also a continuation in part of U.S. Design Patent Application 29/798,782, filed Jul. 9, 2021, the contents of which are incorporated by reference herein in their entirety.

### FIELD OF THE INVENTION

This invention relates to clear kettle with a display applied to or incorporated into a side of the kettle. In particular, the invention relates to a kettle having transparent or translucent walls and a display panel surrounded on at least three sides by the wall.

### BACKGROUND

A wide variety of electric kettles exist for heating a fluid, such as water. Such kettles often provide a control interface, so that a user can activate the kettle to heat the fluid contained therein. Such control interfaces may include a display, such as a digital display, which may be used to present various information to a user. Such information may include a target temperature, an actual temperature, a current or target mode for the kettle, or various other information requested by a user.

Traditionally, such kettles are provided with a base containing electronics for powering and/or controlling the kettle. The kettle may then be placed on the base during a heating process and then removed from the base in order to dispense the fluid contained therein. As such, when removed from the base, the kettle is no longer constrained to a vertical orientation, and fluid can be poured out of the kettle.

Because heating a fluid, such as liquid water, using electricity is very power intensive, the base may be plugged into a wall outlet or the like, and when the kettle is placed on the base, the kettle may draw power from the base to heat the fluid contained therein. This may be through electrical contains through which electricity may be provided to the kettle and passed through resistors or some other heating element integrated into the kettle itself.

Power electronics may be provided in the base, but control electronics can be provided either in the base or in the kettle itself. Because heating is power intensive but operating control electronics is considerably less so, the control electronics may be provided in the base and may be supported by a battery rechargeable by the power electronics when the kettle is placed on the base.

Traditionally, the location of a control interface on such kettles is limited. Where kettles are generally opaque and formed, for example, of plastic, the control panel may be located somewhere on the housing thick enough to protect such control electronics from heat generated by the kettle. Where kettles are clear, such as those formed from clear plastic or glass, the control electronics are generally located either on the base or in a limited set of locations on the kettle that have thickened opaque housings that can be easily electrically connected to the base. Accordingly, such control panels, which may include a control interface having buttons, dials, and the like, as well as a display, have been limited to a bottom housing of the kettle adjacent the base or a handle artificially thickened to allow for such a control interface.

There is a need for an electronic kettle that is not limited aesthetically and functionally to providing a control interface in a base, a handle, or a lower housing of a kettle.

### SUMMARY

A kettle is provided having a fluid chamber having a transparent or translucent wall and a display panel located in or on the transparent or translucent wall, wherein the display panel is surrounded on at least three sides by the translucent or transparent wall.

Typically, the display panel comprises an opaque material, such that the display panel is not transparent or translucent and the remainder of the wall is transparent or translucent.

In some embodiments, the kettle has a fluid chamber with a substantially circular cross section, and the transparent or translucent wall encloses the fluid chamber.

In some embodiments, the kettle further comprises a fluid chamber base. The fluid chamber base has a housing comprising an opaque material, and the housing encloses electronics associated with the kettle. A base of the transparent or translucent wall then mates with the fluid chamber base to define an interior space of the fluid chamber.

In some embodiments, the kettle includes a fixed base for mating with the fluid chamber base. The fixed base includes electrical components and at least one electrical contact. The fluid chamber base then comprises at least one electrical contact for interfacing with the fixed base, and the fixed base provides power to the fluid chamber base.

In some such embodiments the display panel is adjacent the fluid chamber base and has a connecting edge between the display panel and the fluid chamber base. Electrical wiring associated with the display panel then passes through the connecting edge from the fluid chamber base to the display panel.

In some embodiments, the kettle includes a handle segment comprising an opaque material. The handle segment may be adjacent the fluid chamber base and may have a connecting edge between the handle segment and the fluid chamber base. The electrical wiring associated with the display panel may then pass through the connecting edge from the fluid chamber base to the handle segment.

In some embodiments, the display panel is adjacent the handle segment and has a secondary connecting edge between the display panel and the handle segment. The electrical wiring associated with the display panel may then pass through the secondary connecting edge from the handle segment to the display panel.

In some embodiments, the kettle further comprises an upper trim comprising an opaque material, the upper trim having a secondary connecting edge between the upper trim and the handle segment. The display panel may then be adjacent the upper trim and have a tertiary connecting edge between the upper trim and the display panel. Electrical wiring associated with the display panel may then pass through the secondary connecting edge into the upper trim and through the tertiary connecting edge from the upper trim to the display panel.

In some such embodiments, the upper trim may be integrated into a lid of the kettle, and the tertiary connecting edge comprises electrical contacts for connecting the upper trim to the display panel.

In some embodiments, wherein the display panel is an opaque plastic.

In some embodiments, the transparent or translucent wall is a clear glass or plastic.

In some embodiments, the display panel comprises a user interface including controls and a display, and the display provides information associated with an actual status of the kettle or a user selection associated with the kettle.

In some such embodiments, the user interface includes capacitive touch controls. In some such embodiments, controls of the user interface are backlit

### BRIEF DESCRIPTION OF THE DRAWINGS

FIG. 1 is a perspective view of an embodiment of a kettle in accordance with this disclosure.

FIG. 2 is a side view of the kettle of FIG. 1.

FIG. 3 is a back view of the kettle of FIG. 1.

FIGS. 4A and 4B are sectioned views of the kettle 100 of FIG. 1 taken along line 4A-4A and 4B-4B of FIG. 2 respectively.

FIG. 5 is a perspective view of an alternative embodiment of a kettle in accordance with this disclosure.

FIG. 6 is a side view of the kettle of FIG. 5.

FIG. 7 is a back view of the kettle of FIG. 5.

FIG. 8 is a perspective view of an alternative embodiment of a kettle in accordance with this disclosure.

FIG. 9 is a side view of the kettle of FIG. 8.

FIG. 10 is a rear view of the kettle of FIG. 8.

FIG. 11 is a sectioned view of the kettle of FIG. 8 taken along line 11-11 of FIG. 10.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

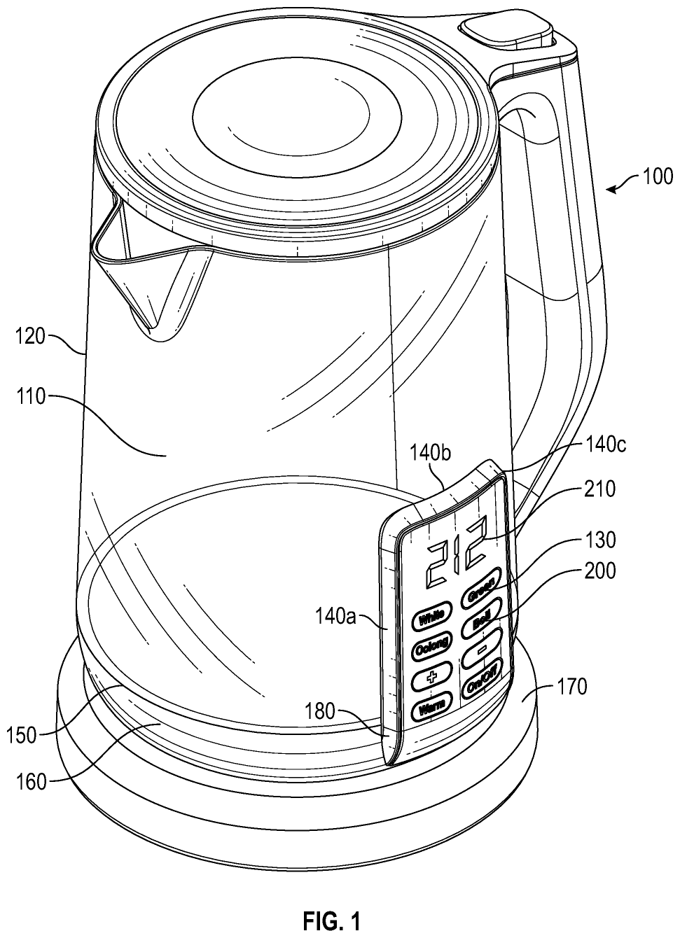

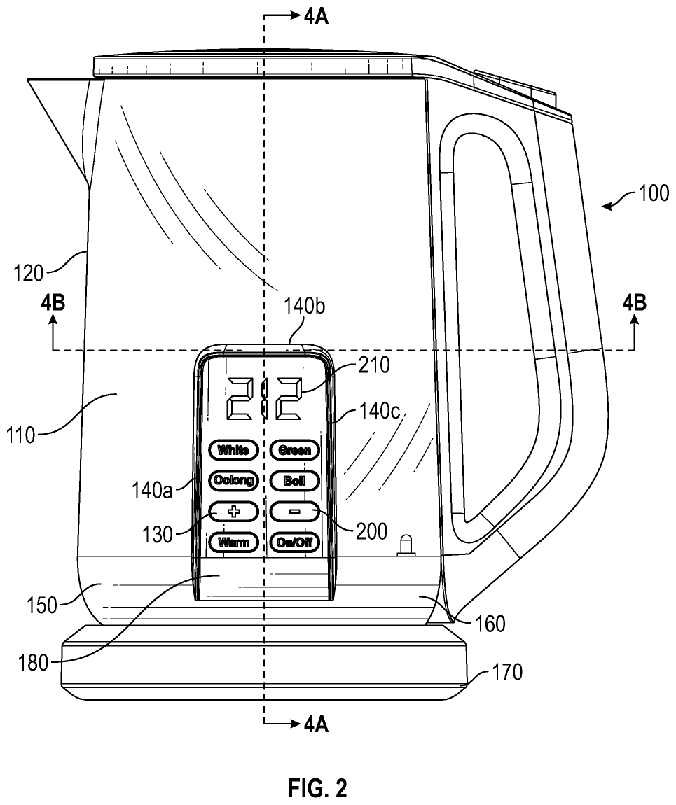

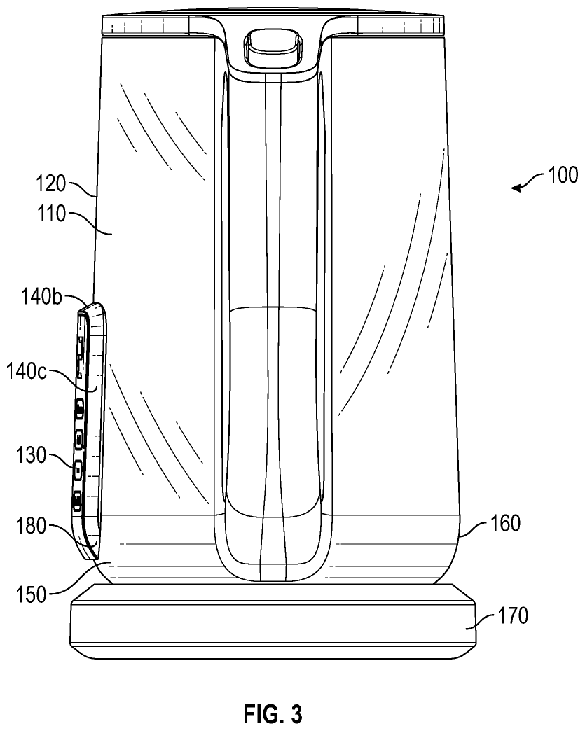

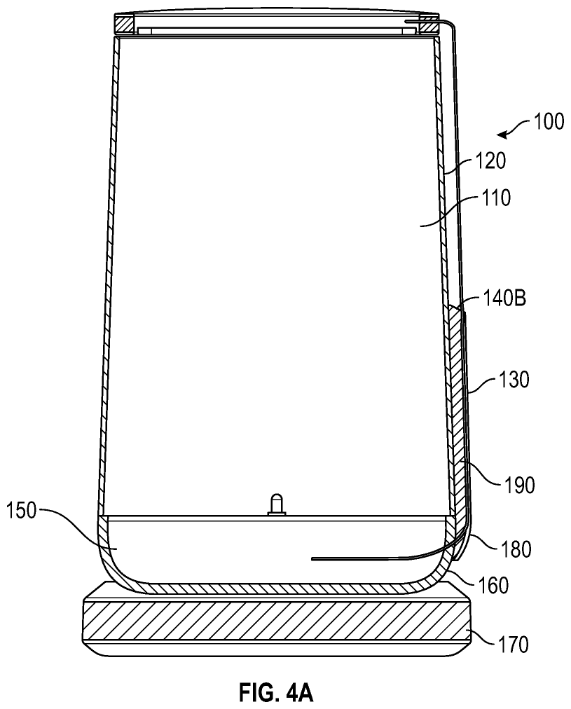

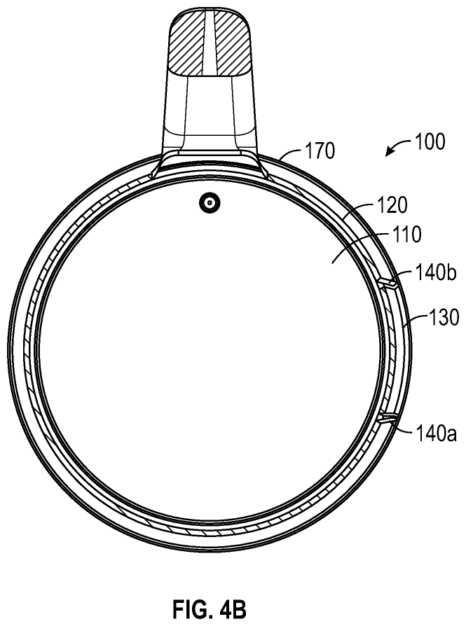

FIG. 1 is a perspective view of an embodiment of a kettle 100 in accordance with this disclosure. FIG. 2 is a side view of the kettle 100 of FIG. 1. FIG. 3 is a back view of the kettle 100 of FIG. 1. FIGS. 4A and 4B are sectioned views of the kettle 100 of FIG. 1 taken along line 4A-4A and 4B-4B of FIG. 2 respectively.

As shown, the kettle 100 generally comprises a fluid chamber 110 for holding a fluid. Generally, the fluid chamber 110 would hold a liquid, such as water, and the kettle 100 would be used to boil the water. The fluid chamber 110 has a transparent or translucent wall 120 and a display panel 130 located in or on the transparent or translucent wall. As shown, the display panel 130 is surrounded on at least three sides 140a, b, c by the translucent or transparent wall 120.

The display panel 130 generally comprises an opaque material. Accordingly, the wall 120 is transparent or translucent, but the display panel is not. The wall 120 may be made of a clear plastic or glass, for example, while the display panel may be made of an opaque plastic or a metal material.

The kettle 100 also may have a fluid chamber base 150. The fluid chamber based 150 generally has a housing 160 comprising an opaque material, and the housing encloses electronics associated with the kettle 100. The fluid chamber base 150 may house, for example, control electronics and/or heating elements associated with the kettle. A base of the transparent or translucent wall 120 may then mate with the fluid chamber base 150 in order to define an interior space of the fluid chamber 110.

The kettle 100 may further comprise a fixed base 170 for mating with the fluid chamber base 150. The fixed base 170 typically comprises electrical components and at least one electrical contact. The fluid chamber base 150 the comprises at least one electrical contact for interfacing with the fixed base 170 when the fluid chamber base is placed on the fixed base. In this way, the fixed base 170 provides power to the fluid chamber base 150.

In some embodiments, the fixed base 170 contains only power electronics, while all control electronics are confined to the fluid chamber 110 portion of the kettle 100. In such embodiments, control electronics may be provided in the fluid chamber base 150, and a battery may be similarly provided therein. The battery may then be charged using power drawn from the fixed base 170 by way of the at least one electrical contact.

Because the fixed base 170 generally contains power electronics for providing power for any heating elements contained within the fluid chamber base 150, the kettle 100 may only be used to heat the fluid contained within the fluid chamber 110 when the fluid chamber base 150 is positioned on the fixed base 170.

In the embodiment shown, the display panel 130 is located adjacent the fluid chamber base 150 and may then have a connecting edge 180 between the display panel 130 and the fluid chamber base 150. In some such embodiments, electrical wiring 190 associated with the display panel 130 may then pass through the connecting edge 180 from the fluid chamber base 150 to the display panel 130.

As shown in FIG. 4B, in some embodiments, the fluid chamber 110 has a substantially circular cross section. In such embodiments, the transparent or translucent wall 120 encloses the fluid chamber 110.

As shown, the display panel 130 typically comprises a user interface, including controls 200 and a display 210. The display 210 provides information associated with an actual status of the kettle 100 or a user selection associated with the kettle, such as a selected mode or the like. The user interface controls 200 may include capacitive touch controls, and such controls of the user interface may be backlit.

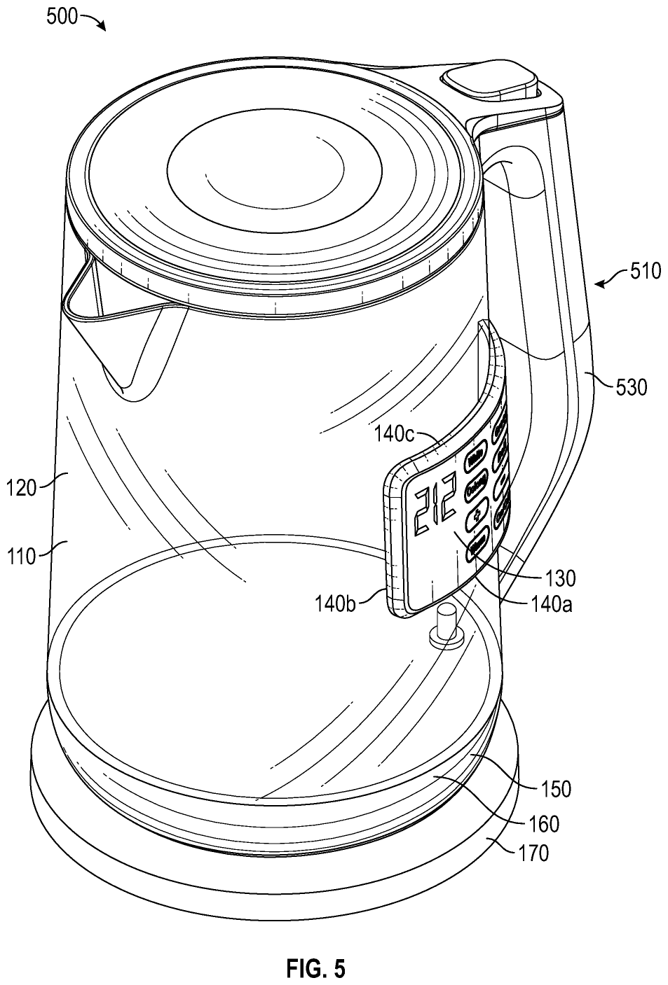

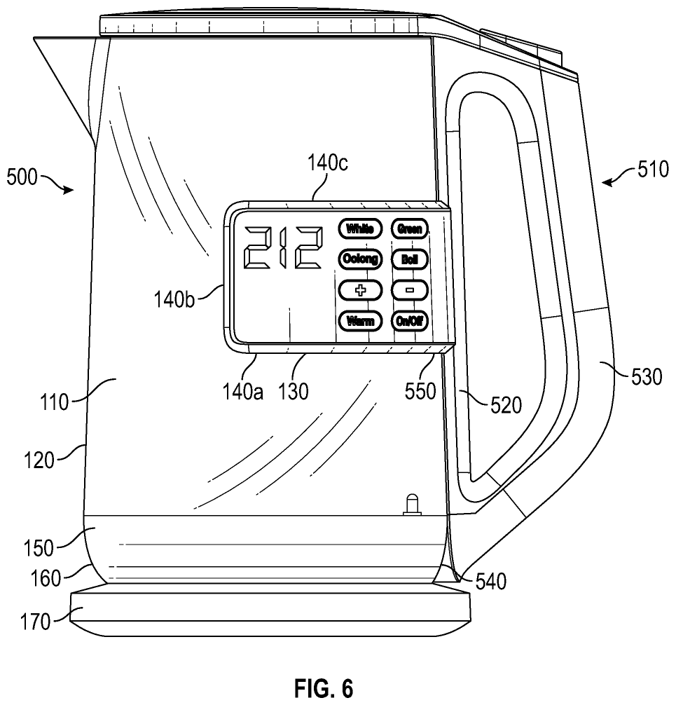

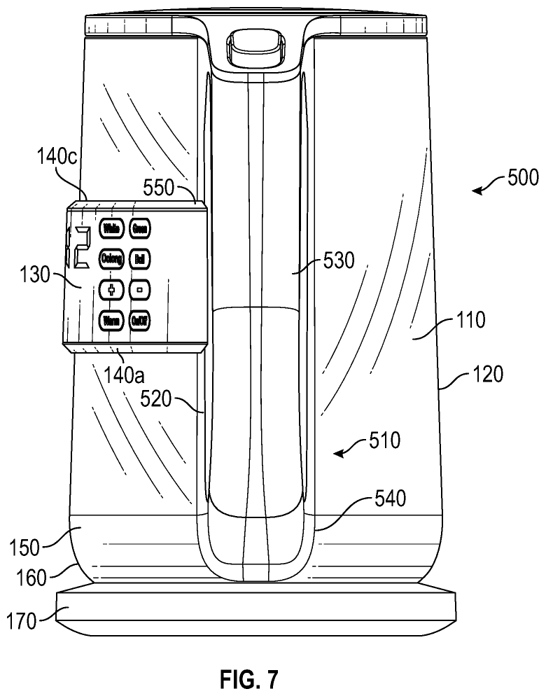

FIG. 5 is a perspective view of an alternative embodiment of a kettle 500 in accordance with this disclosure. FIG. 6 is a side view of the kettle 500 of FIG. 5. FIG. 7 is a back view of the kettle 500 of FIG. 5.

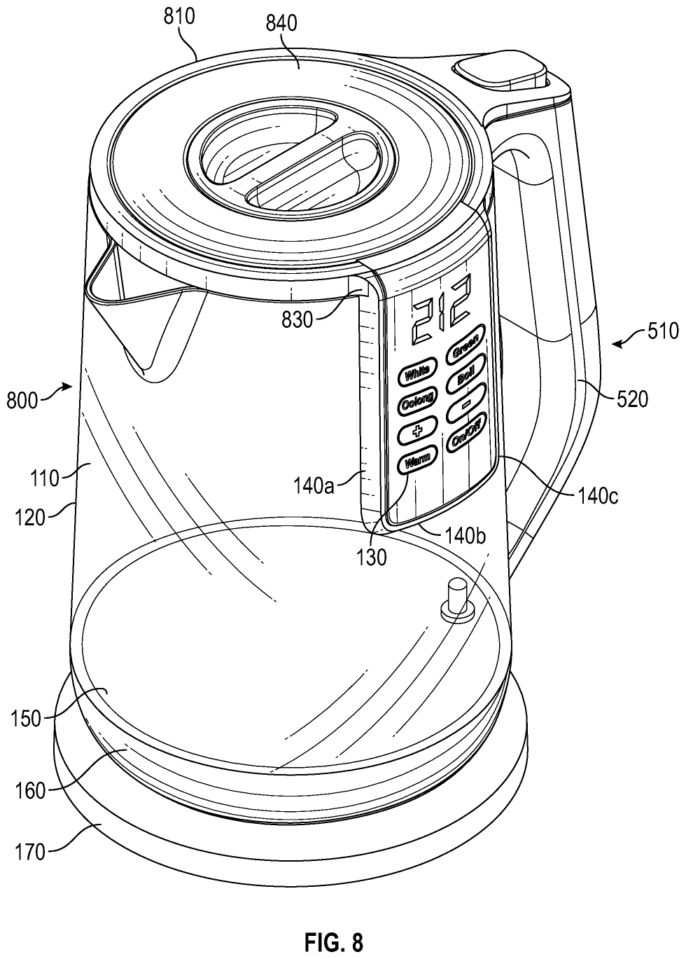

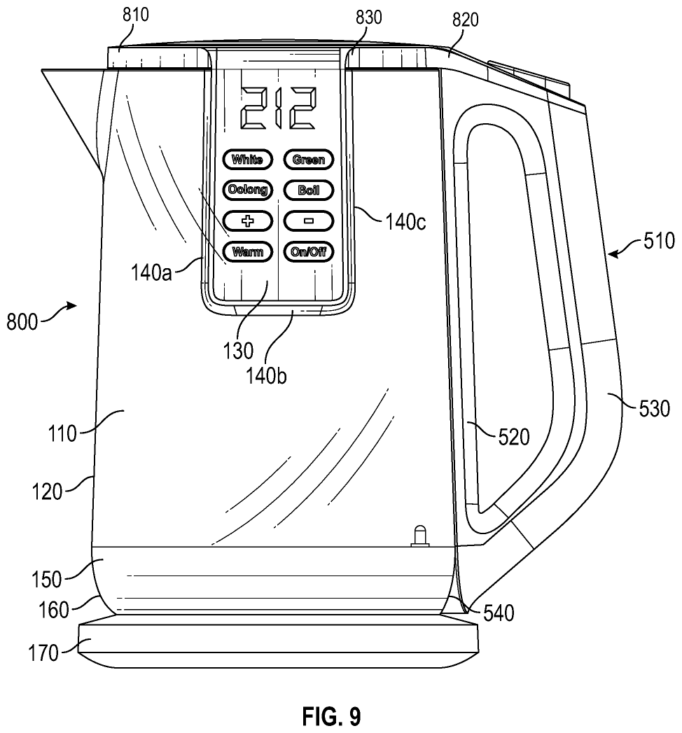

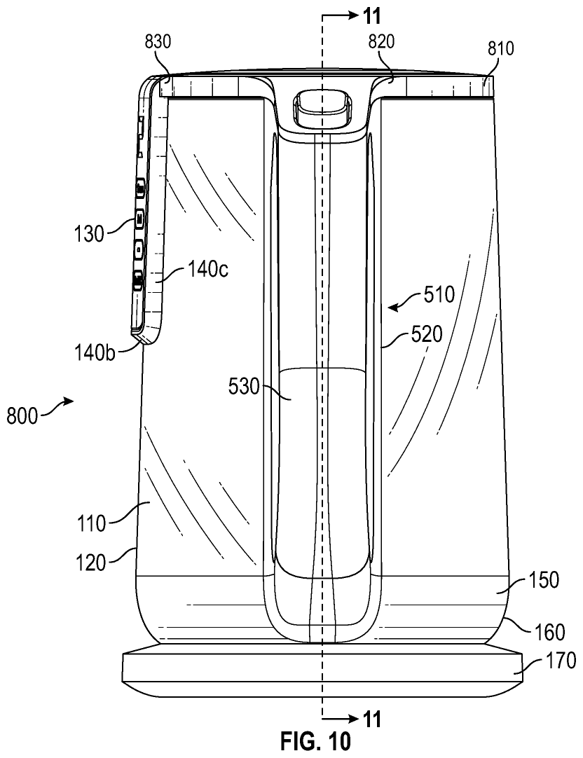

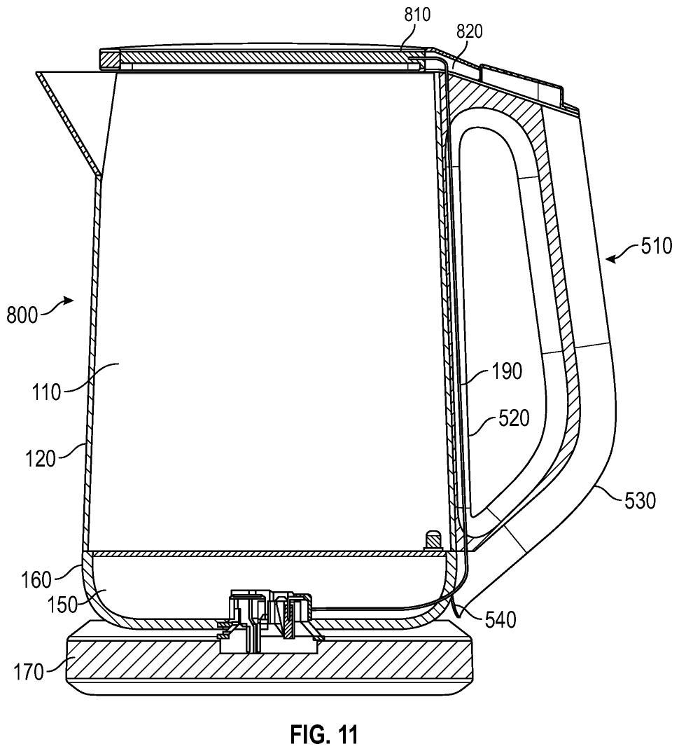

FIG. 8 is a perspective view of an alternative embodiment of a kettle 800 in accordance with this disclosure. FIG. 9 is a side view of the kettle 800 of FIG. 8. FIG. 10 is a rear view of the kettle 800 of FIG. 8. FIG. 11 is a sectioned view of the kettle 800 of FIG. 8 taken along line 11-11 of FIG. 10.

Both the kettle 500 shown in FIG. 5 and the kettle 800 of FIG. 8 are similar to the kettle 100 shown in FIG. 1. As such, components that are similar are provide with the same reference numerals, and only the differences between the embodiments are discussed herein. Accordingly, all three embodiments of the kettle 100, 500, 800, are provided with a fluid chamber 110 having a transparent or translucent wall 120 and a display panel 130 surrounded on at least three sides 140a, b, c by that wall.

As shown, the kettles 100, 500, 800 may be provided with corresponding handle segments 510. The handle segments may be formed from an opaque material, such as plastic, and may comprise a handle base segment 520 and a handle grip segment 530.

The handle segment 510 may be provided adjacent the fluid chamber base 150 and may then have a connecting edge 540 between the handle segment and the fluid chamber base. In such an embodiment, and as discussed above with respect to the connecting edge 180 between the display panel 130 and the fluid chamber base 150 in the kettle 100 of FIG. 1, electrical wiring 190 associated with the display panel 130 may pass through the connecting edge 540 from the fluid chamber base 150 to the handle segment 510.

In some such embodiments, such as the kettle 500 of FIG. 5, the display panel 130 is adjacent the handle segment 510 and has a secondary connecting edge 550 between the display panel 130 and the handle segment 510. The electrical wiring 190 associated with the display panel 130 may then pass through the secondary connecting edge 550 from the handle segment 510 to the display panel 130.

In some such embodiments, the electrical wiring may pass through the handle base segment 520, and as such, the secondary connecting edge 550 may be between the handle base segment and the display panel 130.

In some alternative embodiments, such as the kettle 800 of FIG. 8, the kettle is further provided with an upper trim 810 also comprising an opaque material. The upper trim 810 may then have a secondary connecting edge 820 between the upper trim and the handle segment 510.

In such an embodiment, the display panel 130 may be provided adjacent the upper trim 810. The kettle 800 may then have a tertiary connecting edge 830 between the upper trim 810 and the display panel 130. Electrical wiring 190 associated with the display panel 130 may then pass from the fluid chamber base 150 into the handle segment 510 by way of the connecting edge 540. The electrical wiring 190 may then pass through the secondary connecting edge 820 from the handle segment 510 to the upper trim 810. The wiring 190 may then further pass through the tertiary connecting edge 830 from the upper trim 810 into the display panel 130.

In such embodiments, wiring 190 associated with the display panel 130 passes from the fluid chamber base 150 into the handle segment 510 and from the handle segment into the upper trim 810, and finally, from the upper trim into the display panel 130. Each of the fluid chamber base 150, handle segment 510, upper trim 810 and display panel 130 may be opaque and may be provided, for example, as an opaque plastic or as a metal component, and as such, the wiring 190 remains hidden at all times. Further, the opaque materials may be provided with insulation, so as to protect the wiring 190 from the heat of the fluid in the fluid chamber 110 or the heating electronics in the fluid chamber base 150.

In the kettle 800 of FIG. 8, the wiring 190 may pass through either the handle base segment 520 or the handle grip segment 530, and then passes through the secondary connecting edge 820 adjacent the upper trim 810.

In the embodiments shown, the kettle 100, 500, 800 is provided with a lid 840. Such a lid 840 may be used to enclose the fluid chamber 110 in order to prevent steam from escaping during use and in order to increase the speed at which fluid, such as water, may be heated. Such a lid 840 may be opened in order to provide access to an interior of the fluid chamber 110 such that the kettle 100, 500, 800 may be easily filled. In some embodiments, the upper trim 810 may be integrated into the lid of the kettle 100, 500, 800, such that the trim is lifted away from the top of the transparent or translucent wall 120 when the lid 840 is opened. In some, alternative, embodiments, the trim 810 is fixed to the wall 120 such that the trim frames the lid 840 and remains stationary when the lid is opened. In embodiments where the trim 810 is integrated into the lid 840, the trim may be provided with electrical contacts for connecting the upper trim to the display panel 130 at the tertiary connecting edge 830.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A kettle comprising:
a fluid chamber having a transparent or translucent wall; and
a display panel located in or on the transparent or translucent wall, wherein the display panel is surrounded on at least three sides by the translucent or transparent wall.

2. The kettle of claim 1 wherein the display panel comprises an opaque material, such that the display panel is not transparent or translucent and the remainder of the wall is transparent or translucent.

3. The kettle of claim 1 wherein the fluid chamber has a substantially circular cross section, and wherein the transparent or translucent wall encloses the fluid chamber.

4. The kettle of claim 1 further comprising a fluid chamber base, wherein the fluid chamber base has a housing comprising an opaque material, and wherein the housing encloses electronics associated with the kettle and wherein a base of the transparent or translucent wall mates with the fluid chamber base to define an interior space of the fluid chamber.

5. The kettle of claim 4 further comprising a fixed base for mating with the fluid chamber base, wherein the fixed base comprises electrical components and at least one electrical contact, and wherein the fluid chamber base comprises at least one electrical contact for interfacing with the fixed base, and wherein the fixed base provides power to the fluid chamber base.

6. The kettle of claim 4 wherein the display panel is adjacent the fluid chamber base and has a connecting edge between the display panel and the fluid chamber base and wherein electrical wiring associated with the display panel passes through the connecting edge from the fluid chamber base to the display panel.

7. The kettle of claim 4 further comprising a handle segment comprising an opaque material, the handle segment adjacent the fluid chamber base and having a connecting edge between the handle segment and the fluid chamber base, and wherein the electrical wiring associated with the display panel passes through the connecting edge from the fluid chamber base to the handle segment.

8. The kettle of claim 7 wherein the display panel is adjacent the handle segment and has a secondary connecting edge between the display panel and the handle segment, and wherein the electrical wiring associated with the display panel passes through the secondary connecting edge from the handle segment to the display panel.

9. The kettle of claim 7 further comprising an upper trim comprising an opaque material, the upper trim having a secondary connecting edge between the upper trim and the handle segment, and wherein the display panel is adjacent the upper trim and has a tertiary connecting edge between the upper trim and the display panel, and wherein the electrical wiring associated with the display panel passes through the secondary connecting edge into the upper trim and through the tertiary connecting edge from the upper trim to the display panel.

10. The kettle of claim 9 wherein the upper trim is integrated into a lid of the kettle, and wherein the tertiary connecting edge comprises electrical contacts for connecting the upper trim to the display panel.

11. The kettle of claim 1, wherein the display panel is an opaque plastic.

12. The kettle of claim 1 wherein the transparent or translucent wall is a clear glass or plastic.

13. The kettle of claim 1 wherein the display panel comprises a user interface including controls and a display, wherein the display provides information associated with an actual status of the kettle or a user selection associated with the kettle.

14. The kettle of claim 13 wherein the user interface includes capacitive touch controls.

15. The kettle of claim 13 wherein controls of the user interface are backlit.
